(19) United States
(12) Patent Application Publication
(10) Pub. No.: US 2015/0348016 A1
(43) Pub. Date: Dec. 3, 2015

(54) Providing Customer Identification With Payment Information

(71) Applicant: GOOGLE INC., Mountain View, CA (US)

(72) Inventors: Joseph B. Pearson, Cedar Park, TX (US); Larry L. Bush, O'Fallon, MO (US)

(21) Appl. No.: 14/729,024

(22) Filed: Jun. 2, 2015

Related U.S. Application Data
(60) Provisional application No. 62/006,488, filed on Jun. 2, 2014.

(51) Int. Cl. G06Q 20/36; G06Q 20/20; G06Q 30/02; G06Q 20/32

(52) U.S. Cl. CPC G06Q 20/36; G06Q 20/327; G06Q 20/202; G06Q 30/0226

(57) ABSTRACT

Transmitting customer identifications comprises a digital wallet of a user and a wireless payment instrument. A digital wallet application receives a customer identification from a digital wallet system hosting a customer account. The application receives an input from a user into a user interface of a user computing device, the input instructing the user computing device to transmit the customer identification to a payment instrument. The application instructs the user to position the payment instrument in proximity of the user computing device and initiates a wireless communication with the payment instrument and requests payment instrument data from the payment instrument. The application verifies the payment instrument data based on the payment instrument data and communicates the customer identification to the payment instrument and instructions to provide the customer identification to a merchant system point of sale system when providing payment instrument data to the merchant system point of sale terminal.

### CROSS REFERENCE TO RELATED APPLICATION

This application claims priority to U.S. Provisional Patent Application No. 62/006,488 filed Jun. 2, 2014 and entitled “Systems, Methods, and Computer Program Products for Using Mobile Applications Via Chip Card,” the entire contents of which are hereby fully incorporated herein by reference.

### TECHNICAL FIELD

The present disclosure relates to provisioning a customer identification on a contactless payment instrument to allow providing of joint payment account information and customer account identification.

### BACKGROUND

Contactless payments can be conducted by a payment instrument with a point of sale (“POS”) terminal of a merchant. The payment instrument may be a device such as a chip card, smart card, or other credit card style payment instrument with the capability of communicating with a POS reader via contactless communication.

A user computing device can communicate with the terminal or with a contactless payment instrument via near field communication (“NFC”), BLUETOOTH, barcode, Wi-Fi, infrared, or any other suitable communication technology. The user computing device can host a payment application, such as a digital wallet application module, that can be used to communicate with the contactless payment instrument or a point of sale terminal.

The point of sale terminal can obtain the payment information from the contactless payment instrument. A payment can be initiated by a “tap,” swipe, or other motion of the contactless payment instrument or via a feature selection from the user. The point of sale terminal can submit transaction details to a card network to receive payment from a card issuer associated with the payment instrument.

Users may maintain loyalty accounts with merchant systems and receive and store offers and other data from the merchant systems. To receive loyalty benefits or redeem offers in conventional systems, the user may be required to provide a loyalty card, present offer data, provide a loyalty account number on a keypad of the POS terminal, or perform other required actions.

### SUMMARY

Techniques herein provide computer-implemented methods to transmit customer identifications. Transmitting customer identifications comprises a digital wallet system employing a server configured to manage a digital wallet account for a user. A digital wallet system configures a customer identification for a user. A user computing device receives the customer identification from a digital wallet system hosting a customer account. The user computing device receives an input from a user into a user interface of a user computing device, the input instructing the user computing device to transmit the customer identification to a payment instrument. The user computing device instructs the user to position the payment instrument in proximity of the user computing device and initiates a wireless communication with the payment instrument and requests payment instrument data from the payment instrument. The user computing device verifies the payment instrument based on the payment instrument data and communicates, to the payment instrument, the customer identification and instructions to provide the customer identification to a merchant system point of sale system when providing payment instrument data. The payment instrument stores the customer identification and communicates a wireless notification to a merchant system point of sale terminal when initiating a transaction. The payment instrument receives a request for payment instrument data from the merchant system point of sale terminal and communicates the payment instrument data and the customer identification to the merchant system point of sale terminal. The transaction is conducted and the payment instrument receives a receipt from the merchant system point of sale terminal.

In certain other example aspects described herein, systems and computer program products to transmit customer identifications are provided.

These and other aspects, objects, features and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system to use a payment instrument to transmit a customer ID, in accordance with certain example embodiments.

FIG. 2 is a block flow diagram depicting a method to use a payment instrument to transmit a customer ID, in accordance with certain example embodiments.

FIG. 3 is a block flow diagram depicting a method to transmit a customer ID to a payment instrument, in accordance with certain example embodiments.

FIG. 4 is a block flow diagram depicting a method to initiate a transaction with customer ID on a payment instrument, in accordance with certain example embodiments.

FIG. 5 is a block diagram depicting a computing machine and a module, in accordance with certain example embodiments.

### DETAILED DESCRIPTION OF THE EXAMPLE EMBODIMENTS

### Overview

In an example embodiment, a user computing device provisions a customer identification (“ID”) on a contactless payment instrument to allow providing of joint payment account information and customer account identification. The customer ID is associated with a digital wallet account of a user and communicated to a user computing device. The customer ID is communicated to a contactless payment instrument by the user computing device and stored on a processor of the payment instrument. When the user taps the payment instrument at a point of sale (“POS”) terminal at a merchant system, the payment instrument communicates the customer ID in conjunction with the payment account information. The POS terminal may use the customer ID to retrieve loyalty information, offers, and other suitable data associated with the account of the user.

In an example embodiment, a digital wallet system or other system manages a digital wallet account for a user. As used herein, the digital wallet system represents any suitable digital wallet account manager, such as a credit card issuer, a payment processing system, a banking institution, a user computing device manufacturer, or any other suitable system.

The user associates one or more payment accounts with the digital wallet account. The payment accounts may be credit card accounts, debit accounts, bank accounts, stored value accounts, or any other suitable payment accounts.

The digital wallet system associates a customer ID with the user account. In an example, the customer ID allows any system to identify the digital wallet account of the user on the digital wallet system. The customer ID may allow a requestor to identify loyalty data of the user, offers associated with the digital wallet account, or any other data associated with the user digital wallet account that the user allows to be shared.

In an example, the user receives a contactless payment instrument from an account issuer. The payment instrument may be a physical payment card conforming to typical size and shape to a standard credit card or debit card. The payment instrument may be any other type of payment card, such as a fob, keychain, or any suitable type of device. The payment instrument may have a processor embedded that is capable of communicating to a point of sale (“POS”) terminal, a kiosk, a user computing device, or any suitable processor. The processor of the payment instrument has a secure element or other hardware or software for storing the amount of funds available in the stored value account, the payment account number, the user identification, or any other suitable data. The payment instrument may be issued by the digital wallet system, a credit card issuer, a banking institution, a merchant system, or any suitable party or system.

If the user desires to add the customer ID to the payment instrument, then the user selects the customer ID on the user computing device user interface and selects the customer ID for transmitting. The user provides an input to the user computing device to communicate the customer ID to the payment instrument. The user positions the payment instrument in proximity to the user computing device to allow the communication to occur.

The user computing device establishes a communication with the payment instrument. The user computing device communicates to the payment instrument via near field communication (“NFC”), Bluetooth, Infrared, or any other suitable communication technology. Any available communication technologies will be represented by “NFC” in this description.

After establishing a communication with the payment instrument, the user computing device authenticates the payment instrument. The user computing device may receive payment account information or other data from the payment instrument and compare the information to stored information associated with the user digital wallet account. Alternatively, the user computing device may communicate the received payment account information to the digital wallet system, a payment processing system, the issuer of the payment account, or any suitable system. The user computing device may request an authentication of the payment account or a verification that the payment account is otherwise associated with the user and the customer ID.

Upon a verification of the payment instrument, the user computing device communicates the customer ID to the payment instrument for storage on the processor of the payment instrument. The customer ID may be stored on the processor or in a secure element of the payment instrument.

After receiving and storing the customer ID, the payment instrument is used in a transaction with a merchant system POS terminal. In an example, the user approaches a merchant system POS terminal with one or more items for purchase. The user swipes or taps the payment instrument and initiates a communication between the payment instrument and the POS terminal. The POS terminal may employ a card reader or other hardware or software to communicate wirelessly with the payment instrument via NFC or other suitable technology.

The reader requests payment account information and other suitable data from the payment instrument. The payment instrument assembles the necessary data for responding to the reader. The data may include the payment account number of the payment instrument, the expiration date of the payment instrument, and other suitable data. The payment instrument further accesses the customer ID and prepares the customer ID for communication with the payment account information. The payment instrument then transmits the payment account information and the customer ID to the reader on the POS terminal.

The reader provides the payment account information and the customer ID to the POS terminal. The POS terminal obtains customer loyalty data, offers, and other suitable information from the digital wallet system. For example, the POS terminal communicates the customer ID to the digital wallet system and receives a communication back with any suitable data. The data may be a loyalty account number for the user with the merchant system. In another example, the data may be one or more offers related to the merchant system or one or more of the products being offered. Any other suitable information may be communicated to the POS terminal.

The POS terminal may apply any received data to the pending transaction. For example, if an offer received from the digital wallet system applies a discount to one of the products in the pending transaction, then the POS terminal may apply that discount during the transaction and adjust the total funds required to conduct the transaction. In another example, the POS terminal receives the loyalty account information of the user and takes any suitable action related to the pending transaction. For example, the POS terminal may communicate a total value of the transaction to the digital wallet account to allow loyalty points to accrue. In another example, the POS terminal logs the transaction of the user so that a “free coffee during 10^{th} visit” instance is awarded to the user account. Any other suitable action may be taken that supports the account of the user.

After loyalty rewards, offers, and other suitable actions are taken by the POS terminal, the transaction is conducted with a payment processing system.

By using and relying on the methods and systems described herein, the digital wallet of a user dynamically provides offers and loyalty information to a POS terminal by communicating a customer ID with the payment information from a payment instrument. As such, the systems and methods described herein may be employed to allow merchant POS terminals to access the user loyalty and account data without requiring the user to provide additional cards, or in any other manner enter a loyalty or customer ID or offers. The system is improved for the merchant system in that offers are easily accessed just by communicating with a single payment instrument. The offers are improved for user in that loyalty accounts and offers are easily accessed by the POS terminal without further actions required of the user. Hence, the methods and systems described herein permit users to obtain the benefits of loyalty accounts, offers, and other data without the need to present additional identifying information.

### Example System Architectures

Turning now to the drawings, in which like numerals represent like (but not necessarily identical) elements throughout the figures, example embodiments are described in detail.

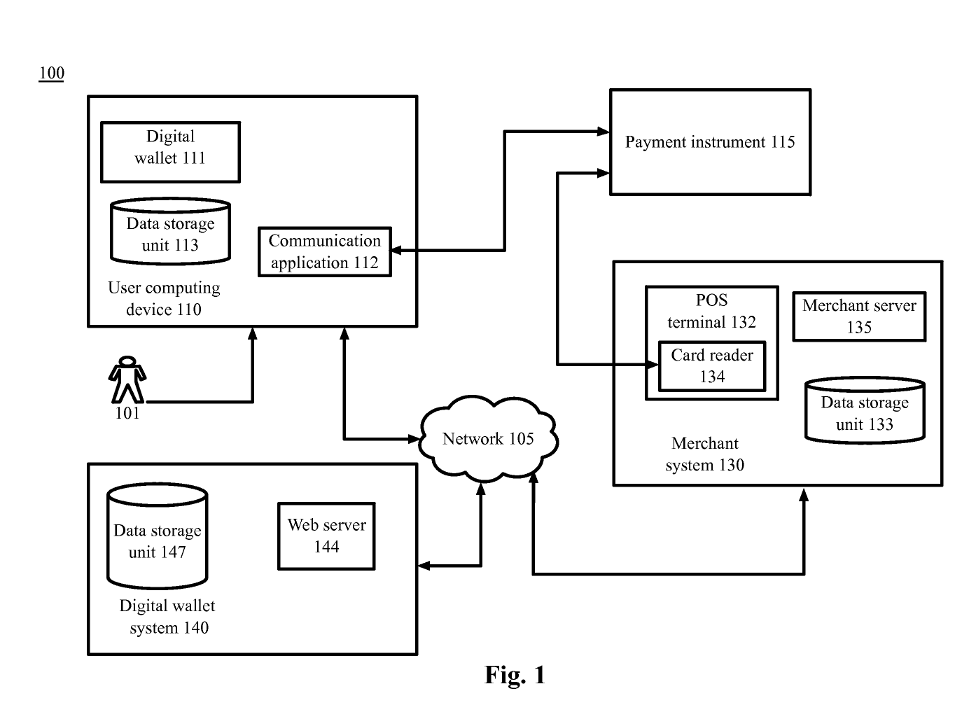

FIG. 1 is a block diagram depicting a system 100 to use a payment instrument to transmit a customer ID, in accordance with certain example embodiments. In some embodiments, a user associated with a device must install an application and/or make a feature selection to obtain the benefits of the techniques described herein.

As depicted in FIG. 1, the system 100 includes network computing devices 110, 130, and 140 that are configured to communicate with one another via one or more networks 105 or via any suitable communication technology.

Each network 105 includes a wired or wireless telecommunication means by which network devices (including devices 110, 130, and 140) can exchange data. For example, each network 105 can include a local area network (“LAN”), a wide area network (“WAN”), an intranet, an Internet, a mobile telephone network, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data. Throughout the discussion of example embodiments, it should be understood that the terms “data” and “information” are used interchangeably herein to refer to text, images, audio, video, or any other form of information that can exist in a computer-based environment. The communication technology utilized by the devices 110, 130, and 140 may be similar networks to network 105 or an alternative communication technology.

Each network computing device 110, 130, and 140 includes a computing device having a communication module capable of transmitting and receiving data over the network 105 or a similar network. For example, each network device 110, 130, and 140 can include a server, desktop computer, laptop computer, tablet computer, a television with one or more processors embedded therein and/or coupled thereto, smart phone, handheld or wearable computer, personal digital assistant (“PDA”), wearable devices such as smart watches or glasses, or any other wired or wireless, processor-driven device. In the example embodiment depicted in FIG. 1, the network devices 110, 130, and 140 are operated by end-users or consumers, merchant system operators, and digital wallet system operators, respectively.

The user 101 can use the communication application 112 on a user computing device 110, which may be, for example, a web browser application or a stand-alone application, to view, download, upload, or otherwise access documents or web pages via a distributed network 105. The communication application 112 can interact with web servers or other computing devices connected to the network 105, including the web server 144 of the digital wallet system 140.

In another example, the communication application 112 communicates with the payment instrument 115 via near field communication (“NFC”) or other wireless communication technology, such as Bluetooth, WiFi, infrared, or any other suitable technology.

The user computing device 110 may include a digital wallet application module 111. The digital wallet application module 111 may encompass any application, hardware, software, or process the user computing device 110 may employ to assist the user 101 in completing a purchase. The digital wallet application module 111 can interact with the communication application 112 or can be embodied as a companion application of the communication application 112. As a companion application, the digital wallet application module 111 executes within the communication application 112. That is, the digital wallet application module 111 may be an application program embedded in the communication application 112. In certain embodiments a digital wallet of the user 101 may reside in a cloud computing environment, on a merchant server, or in any other environment.

The user computing device 110 also includes a data storage unit 113 accessible by the digital wallet application module 111 and the communication application 112. The example data storage unit 113 can include one or more tangible computer-readable storage devices. The data storage unit 113 can be stored on the user computing device 110 or can be logically coupled to the user computing device 110. For example, the data storage unit 113 can include on-board flash memory and/or one or more removable memory accounts or removable flash memory. In certain embodiments, the data storage unit 113 may reside in a cloud based computing system.

The digital wallet system 140 may include a data storage unit 147 accessible by the web server 144. The example data storage unit 147 can include one or more tangible computer-readable storage devices, or the data storage unit may be a separate system, such as, a different physical or virtual machine, or a cloud-based storage service.

The digital wallet system 140 may be any system that manages, configures, enables, or otherwise services a digital wallet for a user 101. The digital wallet system 140 may provide a mechanism for a user 101 to conduct transactions with a merchant system 130. The digital wallet system 140 may provide software or other applications to a user computing device 110 to conduct digital wallet transactions on the user computing device 110.

The digital wallet system 140 may provide the user 101 with a customer identification (“ID”) that identifies the account of the user 101 on the digital wallet system 140. The digital wallet system 140 may utilize the customer ID to access loyalty information of the user 101, stored or associated offers, payment instruments, or other suitable data.

The user 101 may utilize a payment instrument 115. The payment instrument 115 may be a physical payment card conforming to typical size and shape to a standard credit card or debit card. The payment instrument 115 may be any other type of payment card, such as a fob, keychain, or any suitable type of device. The payment instrument 115 may have a processor embedded that is capable of communicating to a point of sale (“POS”) terminal, a kiosk, a user computing device, or any suitable processor via near field communication (“NFC”), Bluetooth, Infrared, Wi-Fi, or any other suitable communication technology. The user computing device 110 employs any hardware or software technologies required to conduct the communications. The processor of the payment instrument 115 has a secure element or other secure or unsecure memory or other hardware or software for storing the amount of funds available in the stored value account, the payment account number, the customer identification, or any other suitable data. The payment instrument 115 may be provided by a card issuer, banking institution, merchant system stored value program, or any other suitable system.

An example merchant system 130 comprises a server 135, a data storage unit 133, a merchant POS terminal 132, and a card reader 134.

In an example embodiment, the server 135 communicates with the digital wallet system 140 to transmit and receive customer IDs, payment information, loyalty information, offers, and other useful data. The merchant server 135 receives data from the POS terminal 132 and assists in conducting transactions with payment processing systems, card issuers, and other suitable systems.

In an example embodiment, the data storage unit 133 can include any local or remote data storage structure accessible to the merchant system 130 suitable for storing information. In an example embodiment, the data storage unit 133 stores encrypted information.

In an example embodiment, the merchant POS terminal 132, such as a cash register, is capable of processing a purchase transaction initiated by a user 101. In an example embodiment, the merchant system 130 operates a commercial store and the user 101 indicates a desire to make a purchase by presenting a form of payment at the merchant POS terminal 132. In an example embodiment, the merchant POS terminal 132 is capable of communicating with the user computing device 110 using an NFC, Bluetooth, and/or Wi-Fi communication method. In an example, the POS terminal 132 utilizes a card reader 134 to communicate with a payment instrument 115 of the user 101. The card reader may receive data from a magnetic stripe, NFC, or any other suitable payment instrument 115 technology.

It will be appreciated that the network connections shown are examples and other means of establishing a communications link between the computers and devices can be used. Moreover, those having ordinary skill in the art having the benefit of the present disclosure will appreciate that the merchant system 130, digital wallet system 140, and the user computing device 110 illustrated in FIG. 1 can have any of several other suitable computer system configurations. For example, a user computing device 110 embodied as a mobile phone or handheld computer may not include all the components described above.

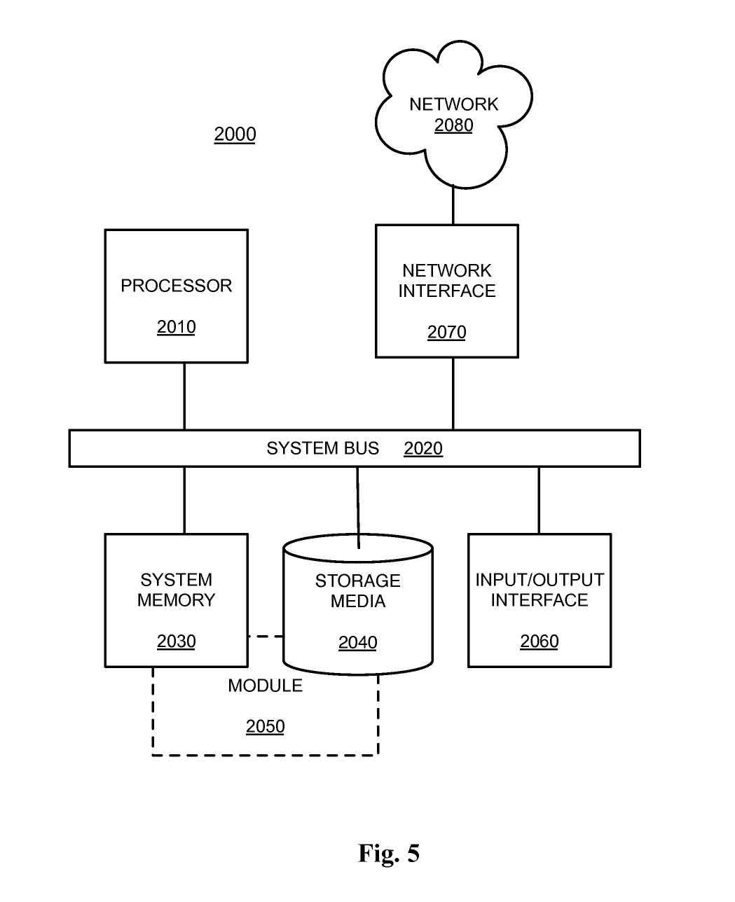

In example embodiments, the network computing devices and any other computing machines associated with the technology presented herein may be any type of computing machine such as, but not limited to, those discussed in more detail with respect to FIG. 5. Furthermore, any modules associated with any of these computing machines, such as modules described herein or any other modules (scripts, web content, software, firmware, or hardware) associated with the technology presented herein may by any of the modules discussed in more detail with respect to FIG. 5. The computing machines discussed herein may communicate with one another as well as other computer machines or communication systems over one or more networks, such as network 105. The network 105 may include any type of data or communications network, including any of the network technology discussed with respect to FIG. 5.

### Example Processes

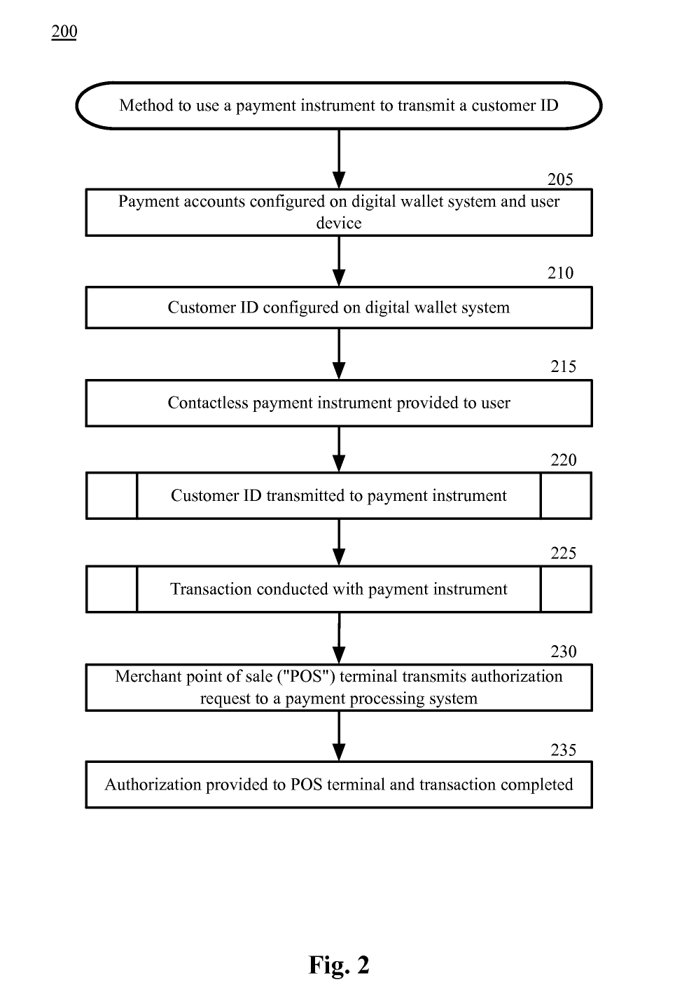

The example methods illustrated in FIG. 2-4 are described hereinafter with respect to the components of the example operating environment 100. The example methods of FIG. 2-4 may also be performed with other systems and in other environments.

FIG. 2 is a block flow diagram depicting a method 200 to use a payment instrument to transmit a customer ID, in accordance with certain example embodiments.

With reference to FIGS. 1 and 2, in block 205, payment accounts are configured on a digital wallet system 140 and a user computing device 110. The user 101 associates one or more payment accounts with a digital wallet account of the user 101 on the digital wallet system 140. The digital wallet system 140 provides software to the user computing device 110 to install a digital wallet application module 111 on the user computing device 110. The user 101 or the digital wallet system 140 may configure the digital wallet application module 111 with the digital wallet data from the digital wallet system 140. In an example, the digital wallet account on the digital wallet system 140 and the digital wallet application module 111 may be configured with one or more payment accounts of the user 101. The payment accounts may be credit card accounts, debit accounts, bank accounts, stored value accounts, or any other suitable payment accounts. The digital wallet account may be configured with loyalty information of the user 101 for one or more merchant systems 130. The digital wallet account may be configured with offers associated with the user 101 from merchant systems 130, manufacturers, or other systems.

In block 210, the customer ID is configured on the digital wallet system 140. The digital wallet system 140 associates a customer ID with the user account. In an example, the customer ID allows any system to identify the digital wallet account of the user 101 on the digital wallet system 140 or the digital wallet application module 111. The customer ID may allow a requestor to identify loyalty data of the user 101, offers associated with the digital wallet account, or any other data associated with the digital wallet account that the user 101 allows. The customer ID may be selected by the user 101, the digital wallet system 140, or other system. Alternatively, the number may be a randomly generated number. The customer ID may be any combination of alphanumeric characters.

In block 215, a contactless payment instrument 115 is provided to the user 101. In an example, the user 101 receives a contactless payment instrument 115 from an account issuer, such as a chip card or a smart card. The payment instrument 115 may be a physical payment card conforming to a typical size and shape of a standard credit card or debit card. The payment instrument 115 may be any other type of payment card or smart card, such as a fob, keychain, or any suitable type of device. The payment instrument 115 may have a processor embedded that is capable of communicating to a point of sale (“POS”) terminal, a kiosk, a user computing device, or any suitable processor. The processor of the payment instrument 115 has a secure element or other hardware or software for storing the payment account number, the user identification, an amount of funds available in a stored value account, or any other suitable data.

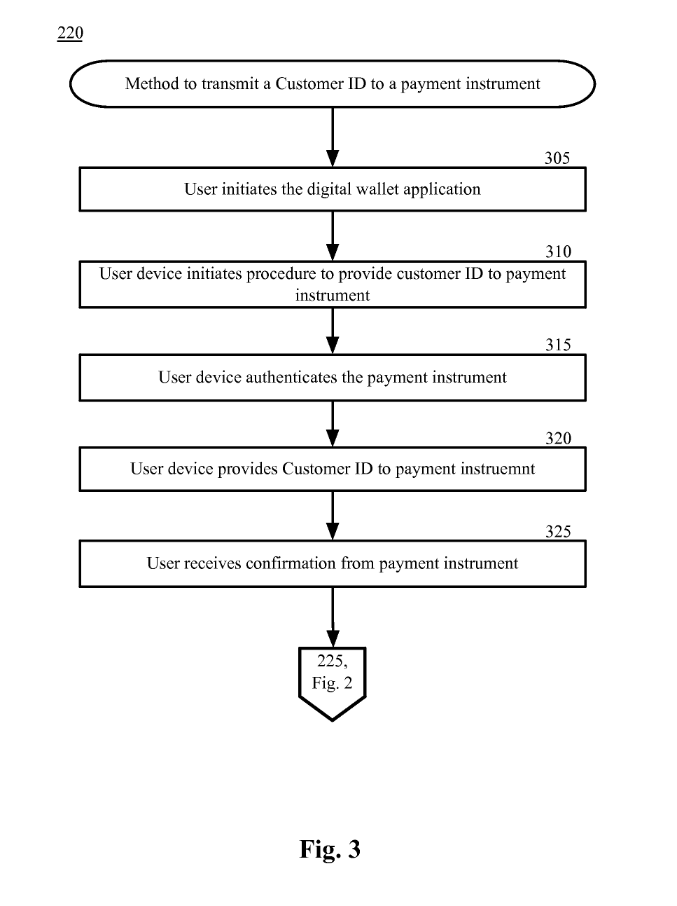

In block 220, the customer ID is transmitted to the payment instrument 115. The details of block 220 are described in greater detail with respect to method 220 of FIG. 3.

FIG. 3 is a block flow diagram depicting a method 220 to transmit a customer ID to a payment instrument 115, in accordance with certain example embodiments.

In block 305, the user 101 initiates the digital wallet application module 111. For example, the user 101 actuates a real or virtual button or other object on the user computing device 110 to open the digital wallet application module 111 or promote the digital wallet application module 111 to the front.

In block 310, the user computing device 110 initiates a procedure to provide customer ID to payment instrument 115. The user 101 provides an input to the user computing device 110 to select an option to communicate the customer ID to the payment instrument.

The user 101 positions the payment instrument 115 in proximity to the user computing device to allow the communication to occur. The digital wallet application module 111 may prompt the user 101 to position the payment instrument 115 in a particular location near the user computing device 110 to improve the communication speed and accuracy. For example, the digital wallet application module 111 may instruct the user 101 to position the bottom portion of the payment instrument 115 near the antenna of a user computing device 110.

In block 315, the user computing device 110 authenticates the payment instrument 115. The user computing device 110 establishes a communication with the payment instrument 115. The user computing device 110 communicates with the payment instrument via near field communication (“NFC”), Bluetooth, Infrared, or any other suitable communication technology. Any of the available communication technologies will be represented by “NFC” in the specification.

After establishing a communication with the payment instrument 115, the user computing device 110 authenticates the payment instrument 115. The user computing device 110 may receive payment account information from the payment instrument 115 and compare the information to stored information associated with the digital wallet account. Alternatively, the user computing device 110 may communicate the received payment account information to the digital wallet system 140, a payment processing system, the issuer of the payment account, or any suitable system. The user computing device 110 may request an authentication of the payment account or a verification that the payment account is otherwise associated with the user 101 and the customer ID.

In block 320, the user computing device 110 provides the customer ID to the payment instrument 115. Upon a verification of the payment instrument 115, the user computing device 110 communicates the customer ID to the payment instrument 115 for storage by the processor of the payment instrument 115 in local storage of the payment instrument 115. The customer ID may be stored on the processor or in a secure element, other secure memory, or other memory of the payment instrument 115 or in any suitable storage location on the payment instrument 115.

In block 325, the user computing device 110 receives a confirmation from the payment instrument 115. The payment instrument 115 communicates to the user computing device 110 that the customer ID is received and stored. The digital wallet application module 111 may display the confirmation to the user 101 on the user interface of the user computing device 110.

From block 325, the method 220 returns to block 225 of FIG. 2.

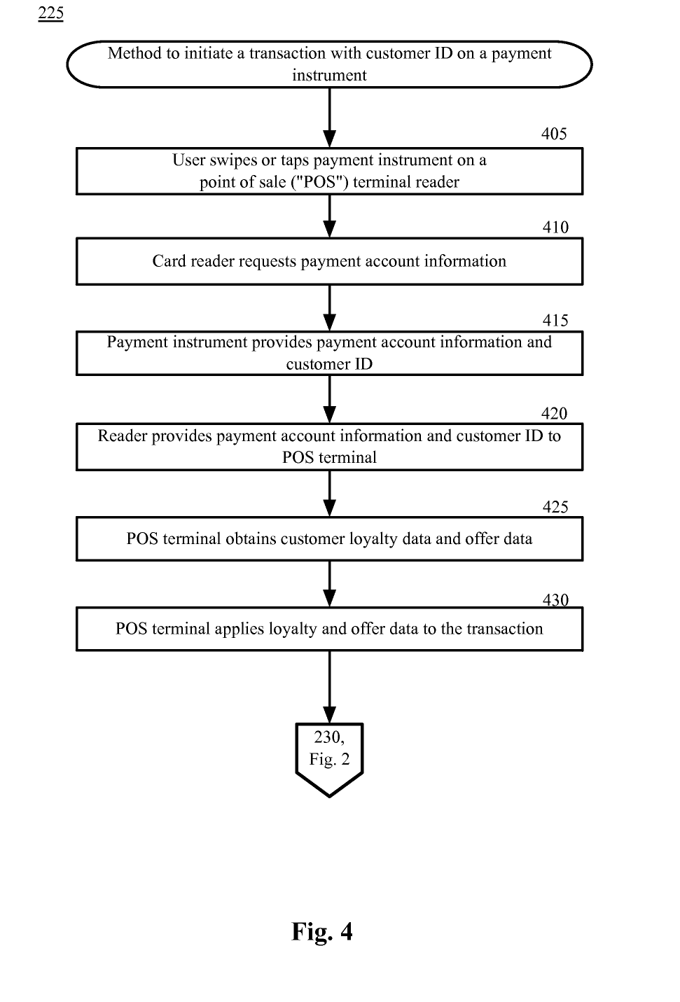

Returning to FIG. 2, in block 225, a transaction is conducted with the payment instrument 115. The details of block 225 are described in greater detail with respect to method 225 of FIG. 4.

FIG. 4 is a block flow diagram depicting a method 225 to initiate a transaction with customer ID on a payment instrument 115, in accordance with certain example embodiments.

In block 405, a user 101 swipes or taps the payment instrument 115 on a point of sale (“POS”) terminal reader 134. After receiving and storing the customer ID, the payment instrument 115 is used in a transaction with a merchant system POS terminal 132. In an example, the user 101 approaches a merchant system POS terminal 132 with one or more items for purchase. The user 101 swipes or taps the payment instrument 115 and initiates a communication between the payment instrument 115 and the POS terminal 132. The tap may represent any action that is required to initiate a communication with the POS terminal 132. For example, the tap may require that the user 101 place the payment instrument 115 flat on a surface of a card reader 134. In another example, the tap may require that the user 101 hover the payment instrument 115 near an antenna of a card reader 134. Any other type of tap, swipe, or other initiating actions, may be employed. The POS terminal 132 may employ a card reader 134 or other hardware or software to communicate wirelessly with the payment instrument 115 via NFC or other suitable technology.

In block 410, the card reader 134 requests payment account information and other suitable data from the payment instrument 115. The payment instrument 115 assembles the necessary data for responding to the reader 134. The data may include the payment account number of the payment instrument 115, the expiration date of the payment instrument 115, and other suitable data. The payment instrument 115 additionally accesses the customer ID and prepares the customer ID for communication with the payment account information.

In block 415, the payment instrument 115 transmits the payment account information and the customer ID to the reader 134 on the POS terminal 132. The communication of the payment account information and the customer ID may be performed simultaneously, sequentially, in a bundled packet of data, or in any suitable manner. For example, the customer ID may be transmitted in a discretionary data field of the payment account information. For example, the payment instrument may tap the payment instrument 115 to the card reader 134 one time, and the customer ID and the payment account information may be bundled together and transmitted to the card reader 134 and communicated simultaneously. The communication may be related to a single transaction that is funded by the payment account information and that is associated with loyalty information, offers, and other customer data associated with the customer ID.

In block 420, the card reader 134 provides the payment account information and customer ID to POS terminal 132. The card reader 134 transmits the collected data to the POS terminal 132 via any available communication technology. For example, the card reader 134 may be a function of the POS terminal 132 and communicate the data via the processor of the POS terminal 132. In another example, the card reader 132 is connected to the POS terminal 132 via a hardwired connection. In another example, the card reader 132 communicates to the POS terminal 132 via a wireless connection. Any other suitable communication method may be employed.

In block 425, the POS terminal 132 obtains customer loyalty data and offer data. The POS terminal 132 communicates with the digital wallet system 140 or any other system to obtain data that is accessible with the customer ID. In an example, the POS terminal 132 determines the identity of the digital wallet system 140 from the payment account information or the customer ID provided by the payment instrument 115. The POS terminal 132 may communicate directly with the digital wallet system 140 via an Internet connection over the network 115 or via any other suitable communication technology. In another example, the POS terminal 132 utilizes the merchant server 135 to communicate to the digital wallet system 140.

The POS terminal 132 obtains the loyalty account data for the user 101 with the merchant system 130. For example, if the user 101 has a loyalty account with the merchant system 130 and has a configured separate loyalty account number, then the POS terminal 132 obtains that information from the digital wallet system 140. That is, the digital wallet system 140 identifies the loyalty account number from a database or other storage location on the digital wallet system 140 based on the customer ID and extracts any loyalty data associated with the customer ID. The digital wallet system 140 transmits the loyalty account number to the merchant system 130 or the POS terminal 134. Loyalty account information, such as reward levels, pending rewards, or other loyalty data may be accessed by the POS terminal 132.

The POS terminal 132 obtains offer data from the digital wallet system 140. For example, if the user 101 has one or more offers related to the merchant system 130 or a product being purchased, the POS terminal 132 identifies and retrieves the offers. That is, the digital wallet system 140 identifies the user account from a database or other storage location on the digital wallet system 140 based on the customer ID and extracts any offer data associated with the customer ID. The digital wallet system 140 transmits the loyalty account number to the merchant system 130 or the POS terminal 134. Any other useful data related to the digital wallet account may be accessed by the POS terminal 132 and utilized in the pending transaction.

In block 430, the POS terminal 132 applies loyalty and offer data to the transaction. For example, if the digital wallet account has stored a 20% off a transaction offer, then the POS terminal 132 may deduct 20% from the transaction total before requesting approval from a payment processing system. In another example, if the user 101 has an offer to “receive a free gift after 10 visits,” then the POS terminal 132 may communicate to the digital wallet system 130 that the user 101 is conducting a “visit” and that the user 101 should receive the appropriate credit. In another example, the POS terminal 132 logs the total amount of the transaction and transmits the total to the digital wallet system 130 to allow the digital wallet system 130 to log the transaction total and apply a configured amount to reward points to the loyalty account of the user 101. Any other suitable action may be taken by the POS terminal 132.

From block 415, the method 225 returns to block 230 of FIG. 2.

Returning to FIG. 2, in block 230, the POS terminal 132 transmits an authorization request a suitable payment processing system. The POS terminal 132 identifies the transaction total and provides an authorization request to a credit card network, a payment processing system, a banking institution, or any suitable system that will provide an authorization for the transaction and process the transaction.

In block 235, the authorization is provided to the POS terminal 132 and the transaction is completed. The POS terminal 132 displays the authorization to the user 101 and/or a salesperson of the merchant system 130. The user 101 receives the purchased product or service and a paper or digital receipt for the transaction.

### Example Systems

FIG. 5 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a wearable computer, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read-only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to transmit customer identifications, comprising:
receiving, using one or more computing devices at a merchant computing system, a notification of a tap of a payment instrument of a user to conduct a pending transaction;
requesting, using the one or more computing devices at the merchant computing system, payment account information from the payment instrument;
receiving, using the one or more computing devices at the merchant computing system, payment account information from the payment instrument;
requesting, using the one or more computing devices at the merchant computing system, a customer identification from the payment instrument;
receiving, using the one or more computing devices at the merchant computing system, the customer identification from the payment instrument, the customer identification having been received by the payment instrument from a user computing device;
communicating, using the one or more computing devices at the merchant computing system, the customer identification to a digital wallet computing system associated with the user;
receiving, using the one or more computing devices at the merchant computing system, a set of data associated with the user from the digital wallet computing system, the data comprising loyalty data and one or more offers associated with the digital wallet account of the user; and
applying, using the one or more computing devices at the merchant computing system, the received data to the pending transaction.

2. The computer-implemented method of claim 1, further comprising revising, using the one or more computing devices at the merchant computing system, a transaction total based on one of the one or more received offers associated with the digital wallet account of the user.

3. The computer-implemented method of claim 1, wherein the payment instrument is a smart card.

4. The computer-implemented method of claim 1, wherein the payment instrument and the one or more computing devices at the merchant computing system communicate via near field communication.

5. The computer-implemented method of claim 1, wherein the payment account information and the customer identification are transmitted simultaneously from the payment instrument to the one or more computing devices at the merchant computing system.

6. The computer-implemented method of claim 1, wherein the payment account information and the customer identification are transmitted from a secure element on the payment instrument to the one or more computing devices at the merchant computing system.

7. The computer-implemented method of claim 1, further comprising communicating, using the one or more computing devices at the merchant computing system, to the digital wallet system data related to the pending transaction, the data being sufficient for the digital wallet system to update the loyalty data associated with the digital wallet account of the user.

8. A computer program product, comprising:
a non-transitory computer-readable storage device having computer-executable program instructions embodied thereon that when executed by a computer cause the computer to transmit customer identifications, the computer-executable program instructions comprising:
computer-executable program instructions to receive a customer identification from a digital wallet computing system hosting a customer account;
computer-executable program instructions to receive an input from a user into a user interface of a user computing device, the input instructing the user computing device to transmit the customer identification to a payment instrument;
computer-executable program instructions to instruct the user to position the payment instrument in proximity of the user computing device;
computer-executable program instructions to initiate a wireless communication with the payment instrument;
computer-executable program instructions to request payment instrument data from the payment instrument;
computer-executable program instructions to verify the payment instrument based on the payment instrument data; and
computer-executable program instructions to communicate the customer identification to the payment instrument and instructions to provide the customer identification to a merchant system point of sale system when providing payment instrument data to the merchant system point of sale terminal.

9. The computer program product of claim 8, wherein the payment instrument is a smart card.

10. The computer program product of claim 8, wherein the user computing device and the payment instrument communicate via near field communication.

11. The computer program product of claim 8, wherein the customer identification are transmitted to a secure element on the payment instrument.

12. The computer program product of claim 8, further comprising computer-executable program instructions to communicate to the payment instrument, instructions to transmit the payment account information and the customer identification to the merchant system point of sale terminal simultaneously.

13. The computer program product of claim 8, wherein the payment instrument is verified by the digital wallet computing system hosting a customer account.

14. A system to select payment accounts to transmit customer identifications, comprising:
a user computing device comprising a user computing device processor communicatively coupled to a user computing device storage resource, wherein the user computing device processor executes application code instructions that are stored in the user computing device storage resource to cause the user computing device processor to:
receive a customer identification from a digital wallet computing system hosting a customer account;
receive an input from a user into a user interface of a user computing device, the input instructing the user computing device to transmit the customer identification to a payment instrument;
instruct the user to position the payment instrument in proximity of the user computing device;
initiate a wireless communication with the payment instrument;
request payment instrument data from the payment instrument;
verify the payment instrument based on the payment instrument data; and
communicate the customer identification to the payment instrument and instructions to provide the customer identification to a merchant system point of sale system when providing payment instrument data to the merchant system point of sale terminal, and
a payment instrument comprising a payment instrument processor communicatively coupled to a payment instrument storage resource, wherein the payment instrument processor executes application code instructions that are stored in the payment instrument storage resource to cause the payment instrument processor to:
receive a wireless communication from the user computing device, the communication requesting payment instrument data;
communicate payment instrument data to the user computing device;
receive, from the user computing device, the customer identification associated with a customer account and instructions to provide the customer identification to a merchant computing system point of sale system when providing payment instrument data to the merchant system point of sale terminal;
store the customer identification;
communicate a wireless notification to a merchant computing system point of sale terminal;
receive a request for payment instrument data from the merchant computing system point of sale terminal;
communicate the payment instrument data and the customer identification to the merchant computing system point of sale terminal; and
receive a receipt from the merchant computing system point of sale terminal.

15. The system of claim 14, wherein the payment instrument is a smart card.

16. The system of claim 14, wherein the user computing device processor and the payment instrument processor communicate via near field communication.

17. The system of claim 14, wherein the payment instrument processor comprises a secure element, and wherein the customer identification is stored on the secure element on the payment instrument processor.

18. The system of claim 14, wherein the payment account information and the customer identification are communicated to the merchant computing system point of sale terminal simultaneously from the payment instrument.

19. The system of claim 14, further comprising verifying, by the user computing device processor, the payment instrument data by communicating the payment instrument data to a digital wallet system hosting the customer account.
